(19) United States
(12) Patent Application Publication
(10) Pub. No.: US 2026/0123580 A1
(43) Pub. Date: May 7, 2026

(54) AUTOMATED OPERATIONAL STATE OF A HARVESTING MACHINE HEADER

(71) Applicant: DEERE & COMPANY, MOLINE, IL (US)

(72) Inventor: JEREMY J. FAUST, North Liberty, IA (US)

(21) Appl. No.: 19/308,857

(22) Filed: Aug. 25, 2025

Related U.S. Application Data
(60) Provisional application No. 63/715,267, filed on Nov. 1, 2024.

(51) Int. Cl. A01D 41/14

(52) U.S. Cl. CPC A01D 41/141

(57) ABSTRACT

A method comprising: determining when a header of a harvesting machine has raised; selectively deactivating one or more header components while the header has raised; determining when a header has lowered; and activating the one or more previously deactivated header components when the header has lowered. A system comprising: a harvesting machine with a header for generating harvested crop; a header sensor configured to determine when the operational state of the header of the has been changed; a forward looking sensor configured to determine when the header has been sufficiently unloaded of harvested crop; and a controller configured to selectively deactivate or activate one or more components of the header when the operational state of the header is changed.

### CROSS-REFERENCE TO RELATED APPLICATIONS

This application claims the benefit of U.S. Provisional Application No. 63/715,267, filed on 1 Nov. 2024, the disclosure of which is incorporated by reference.

### TECHNICAL FIELD

The disclosure generally relates to the field of a harvesting machine, and more particularly relates to the automated operational state of a harvesting machine header.

### BACKGROUND

A harvesting machine may include a header (e.g., corn header, draper head, windrower with draper head) to perform a harvesting operation. Typically, the harvesting machine has a location sensor (e.g., global positioning system sensor) that determines the location of the harvesting machine. As the harvesting machine moves, the location sensor collects location data and a heading (e.g., an orientation of the harvesting machine) of the harvesting machine is calculated based on changes in location data corresponding to the motion of the harvesting machine. The harvesting machine turns around after harvesting one or more rows in an area referred to as a headland during which the header often remains running even though the header is relatively empty of harvested material. Thus, the header may unnecessarily operate in a portion of the headland, which may result in unnecessary cost, time, or damage to the header.

### SUMMARY

A method comprising: determining when a header of a harvesting machine has raised; selectively deactivating one or more header components while the header has raised; determining when a header has lowered; and activating the one or more previously deactivated header components when the header has lowered.

A method comprising: determining when a header of a harvesting machine has been raised; determining when the header has been sufficiently unloaded of harvested crop; and selectively deactivating one or more components of the header.

A system comprising: a harvesting machine with a header for generating harvested crop; a header sensor configured to determine when the operational state of the header of the harvesting machine has been changed; a forward looking sensor configured to determine when the header has been sufficiently unloaded of harvested crop; and a controller configured to selectively deactivate or activate one or more components of the header when the operational state of the header is changed.

### BRIEF DESCRIPTION OF DRAWINGS

The disclosed examples have other advantages and features which will be more readily apparent from the detailed description, the appended claims, and the accompanying figures (or drawings). A brief introduction to the figures is below.

FIG. 1 illustrates a block diagram of a system environment for a harvest management system, according to an example.

FIG. 2 illustrates a block diagram of modules and databases used by a harvest management system, according to an example.

FIG. 3 illustrates a side view of a harvesting machine and header with the header in a lowered position, according to an example.

FIG. 4A illustrates a top view of a harvesting machine with a header in a lowered position and full of harvested crop, according to an example.

FIG. 4B illustrates a side view of a harvesting machine with a header in a lowered position and full of harvested crop, according to an example.

FIG. 4C illustrates a front view of a harvesting machine with a header in a raised position and empty of harvested crop, according to an example.

FIG. 5 illustrates a top view of a harvesting machine and header entering a headland, according to an example.

FIG. 6 illustrates a top view of a harvesting machine and header exiting a headland, according to an example.

FIG. 7 illustrates a screenshot of a control interface for controlling a harvesting machine, according to an example.

FIG. 8 illustrates a flowchart of a method for automatically deactivating and activating header components for a harvesting machine, according to an example.

### DETAILED DESCRIPTION

With advances in technology, including electrification of harvesting machine 130 and header 325 technology, it is desirable for a header 325 and header 325 components to be selectively activated and/or deactivated in certain areas of a field. In the present disclosure, a harvesting machine 130 is provided which automates deactivation of the header 325 when entering the headland or other area and activation of the header 325 when exiting the headland or other area. The Figures (FIGS.) and the following description relate to preferred examples by way of illustration only. It should be noted that from the following discussion, alternative examples of the structures and methods disclosed herein will be readily recognized as viable alternatives that may be employed without departing from the principles of what is claimed.

When harvesting fields with a harvesting machine 130, specifically fields with terraces, waterways or headlands, the header 325 is frequently lifted to move between areas including areas of harvested and unharvested crop. This happens to avoid terraces, to skip areas where crops have already been harvested, or to take a headland turn. When the header 325 is lifted, the operator allows the header 325 and the header 325 components (including for example the draper belts, reel, and cutter bar) to continue to run even after the crop has made its way through header 325 and into the feederhouse 160 of the combine. In areas of high terraces where the operator is frequently lifting the header 325, this situation can occur for a significant amount of time, wasting significant amounts of power and energy to drive the header 325 functionality.

In one example, the present disclosure provides a way to reduce this waste by detecting when the header 325 is lifted/raised, the crop has made its way through the header 325 to the feederhouse 160 and the header 325 is sufficiently unloaded of harvested crop, and deactivating and/or activating certain header 325 components (the draper belts, reel and cutter bar). In one example, the harvesting machine 130 determines when the header 325 changes operational state (e.g., raised transport state) via sensors on the feederhouse 160, hydraulic solenoid timing, or a switch. The harvesting machine 130 being configured to, either concurrently or simultaneously with change in operational state of the header 325, use forward looking cameras 335 (or another camera that can see header 325 components) to determine when the header 325 and/or header 325 components has been sufficiently unloaded or cleared of the harvested crop. When the system determines that there is no longer crop loaded on the header 325 or header 325 components, the harvesting machine 130 may automatically power down header 325 functionality (e.g., draper belts, reel and cutter bar) thus conserving power, as it is known that no crop will be coming into the header 325.

Once the header 325 again changes operational state (e.g., lowered into a harvesting position), the header 325 components can be automatically activated (or in some cases reactivated) by the harvesting machine 130 and/or harvest management system. Lowering the header 325 can again be determined by one or more feederhouse position sensors, switches, and hydraulic solenoids. Alternatively, the header 325 components may be activated or deactivated based on inputs from forward looking cameras 335 configured to determine if the header 325 is in a raised or lowered position by measuring the height of certain header 325 components (e.g., cutter bar) from the ground.

In addition, the harvesting machine 130 may determine that crop has cleared header 325 components such as the draper belts by measuring draper motor torque and determining if it is loaded or measuring the weight of the draper belts. Further, in addition to using sensing methods for header 325 height for determining whether the header 325 is no longer harvesting crop, one could also use coverage maps to determine when the combine is in a region that has already been harvested. In this example, the harvesting machine 130 would still be fitted with cameras and camera detection to understand when crop has been cleared from the draper belts.

In another example, a header 325 for harvesting corn is provided where in the header 325 components would comprise corn header 325 or pick up header 325 and be similar to drapers by measuring whether crop is loaded on the gathering chains or on the pickup head belt. Finally, it is contemplated that the harvesting machine 130 may be a windrower with draper heads.

Reference will now be made in detail to several examples, examples of which are illustrated in the accompanying figures. It is noted that wherever practicable similar or like reference numbers may be used in the figures and may indicate similar or like functionality. The figures depict examples of the disclosed system (or method) for purposes of illustration only. One skilled in the art will readily recognize from the following description that alternative examples of the structures and methods illustrated herein may be employed without departing from the principles described herein.

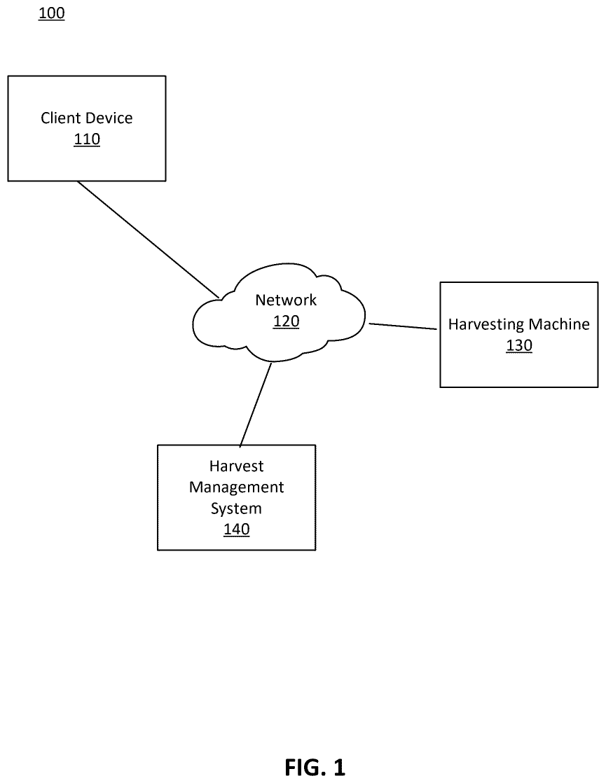

FIG. 1 illustrates a block diagram of a system environment 100 for a harvest management system, according to an example. The system environment 100 includes a client device 110, a network 120, a harvesting machine 130, and a harvest management system 140. The system environment 100 may have alternative configurations than shown in FIG. 1 and include different, fewer, or additional components.

The client device 110 is a device used by a user to operate the harvesting machine 130. For example, the user may be an employee associated with the harvest management system 140, a third-party individual, or an individual associated with a field where the harvesting machine 130 is being used (e.g., a farmer that owns the field). The harvesting machine 130 may be controlled manually, remotely based on inputs from the client device 110 or operate semi-autonomously based on inputs describing the tasks to be performed by the harvesting machine 130 such as types of tasks, time at which the tasks are to be performed, portions of the field in which the tasks are to be performed, and other information for operating the harvesting machine 130. In other examples, the harvesting machine 130 may be autonomous and operate without input from the user. The client device 110 is configured to communicate with the harvesting machine 130 and/or the harvest management system 140 via the network 120, for example using a native application executed by the computing device and provides functionality of the harvest management system 140, or through an application programming interface (API) running on a native operating system of the computing device, such as IOS® or ANDROID™. The client device 110 may be a conventional computer system, such as a desktop or a laptop computer. Alternatively, the client device 110 may be a device having computer functionality, such as a personal digital assistant (PDA), a mobile telephone, a smartphone, or another suitable device. The client device 110 may be integrated with the harvesting machine 130 (e.g., a console within the harvesting machine 130). The client device 110 include the hardware and software needed to input and output sound (e.g., speakers and microphone) and images, connect to the network 120 (e.g., via Wi-Fi and/or 4G or other wireless telecommunication standards), determine the current geographic location of the client device 110 (e.g., a Global Positioning System (GPS) unit), and/or detect motion of the client device 110 (e.g., via motion sensors such as accelerometers and gyroscopes).

The client device 110 is configured to communicate via network 120, which may comprise any combination of local area and/or wide area networks, using both wired and/or wireless communication systems. In one example, network 120 uses standard communications technologies and/or protocols. For example, the network 120 includes communication links using technologies such as a control area network (CAN), Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some examples, all or some of the communication links of network 120 may be encrypted using any suitable technique or techniques.

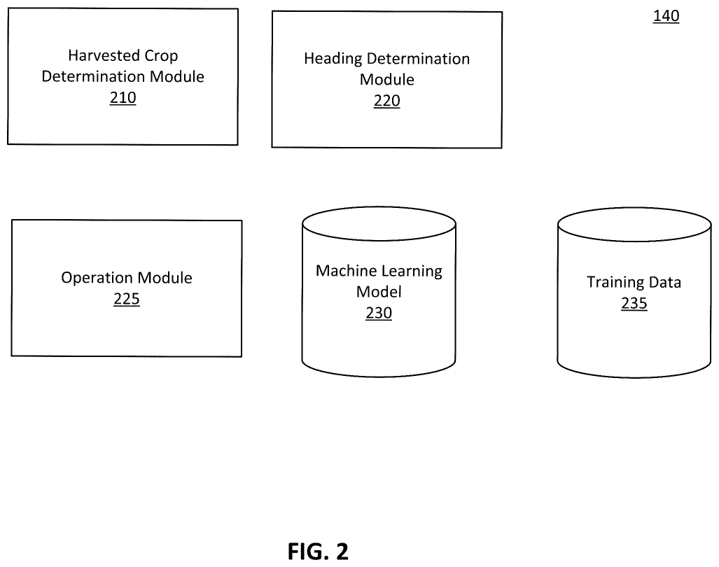

FIG. 2 illustrates a block diagram of modules and databases used by a harvest management system, according to an example. The harvest management system 140 includes a harvested crop determination module 210, a heading determination module 220, an operation module 225, a machine learning model database 230, and a training data database 235. The modules and databases depicted in FIG. 2 are merely exemplary; more or fewer modules and/or databases may be used by the action recommendation system 130 to achieve the functionality described herein. Moreover, these modules and/or databases may be located in a single server or may be distributed across multiple servers. Some functionalities of the harvest management system 140 may be performed by the farming machine 130.

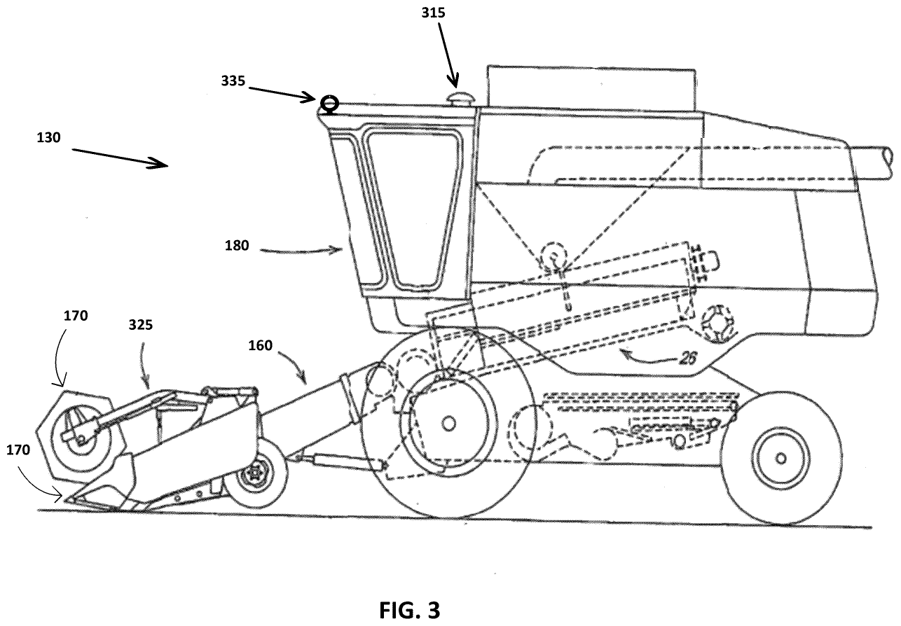

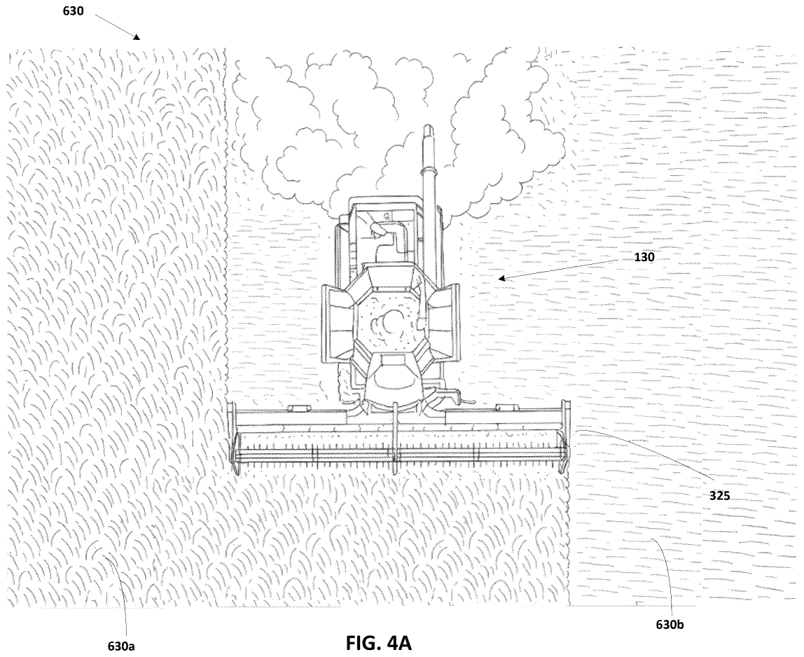

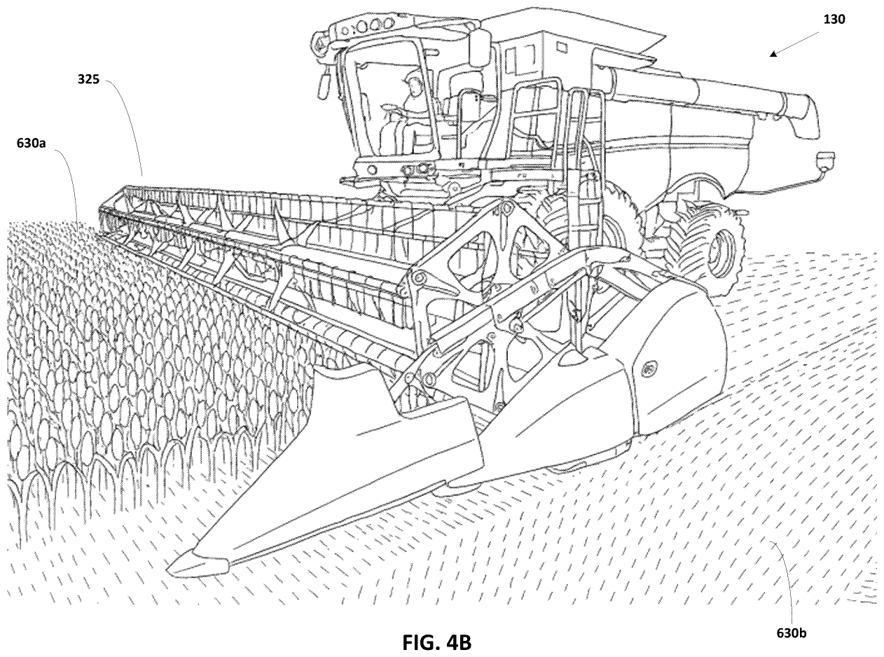

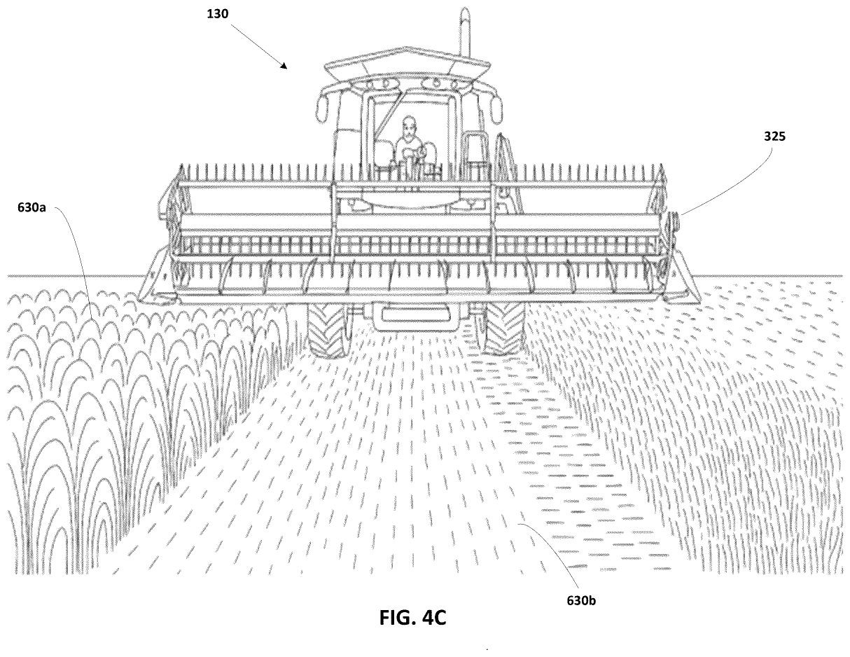

In one example, the harvested crop determination module 210 processes an image of the header 325 captured by a forward looking camera 335 to determine the operational state of the header 325 (lowered see FIGS. 3 and 4A-B; raised see FIG. 4C), activation or deactivation of one or more header 325 components 170 and the amount of harvested crop remaining on the header 325, i.e., crop that has been removed from the surface of the field and is being moved to an internal area (e.g., a feederhouse 160 in) of the harvesting machine 130 for processing (full header 325 see FIGS. 4A-B; empty header 325 see FIG. 4C). In some examples, the harvested crop determination module 210 may also modify the image (e.g., resizing, delayering, cropping, value normalization and adjusting image qualities such as contrast, brightness, exposure, temperature). The harvested crop determination module 210 receives the image from the camera 335 and applies a machine learning model 230 to performing image recognition to identify the portion of the image including pixels that represent the header 325 and/or harvested crop. In some examples, the machine learning model 230 is a supervised model that is trained to output an amount of harvested crop remaining in the header 325. The machine learning model 230 may be a neural network, decision tree, or other type of computer model, and any combination thereof. Training data 235 for the machine learning model 230 may include training images of historical header 325 and harvested crop captured by cameras 335 installed on various historical harvesting machine 130. Each training image may be labeled to include a bounding box around at least a portion of the historical header 325. The bounding box may be drawn by a human annotator to include the portion of the image including the historical header 325. In some examples, there may be one or more fiducial markers at known locations on each historical header 325 (e.g., at a center point of header 325), and a human annotator may place a bounding box around the fiducial marker.

For each training image, the intrinsic parameters such as local length, skew, distortion, and image center and extrinsic parameters such as position and orientation of the camera 335 that captured the training image are known. Based on these camera parameters and the position of the bounding box within the training image, the direction of the historical header 325 can be determined. Each training image may be associated with additional information and the additional information is provided along with the training image. The additional information includes the dimensions of the historical harvesting machine 130 and/or the historical header 325, intrinsic and/or extrinsic parameters of the corresponding camera 335, and other relevant features regarding the configuration of the historical harvesting machine 130. Dimensions of the historical harvesting machine 130 may include length, width, height of the historical harvesting machine 130 and dimensions of the header 325 may include length, width, and height and respective positions of the header 325 relative to the harvesting machine 130.

In an alternative example, harvested crop determination module determines when the header 325 is lifted from one operational state, e.g., in a lowered position proximate the ground for harvesting crop (see FIGS. 4A-B), to another operational state, e.g., in a raised/transport (see FIG. 4C). Harvested crop determination modules may determine changes in operational states using one or more forward looking cameras 335, sensors on the feeder house or header 325, a hydraulic solenoid timing, and a switch in the operator cab 180 of the harvesting machine 130.

In another example, harvested crop determination module may further use one more cameras 335—the forward looking cameras 335 mounted on the harvesting machine 130 and/or a separate camera that can see the header 325 and/or a component of the header 325 such as a draper belt—to determine when the header 325 has cleared the harvested crop from one or more components and into the feeder house (e.g., see FIG. 4C). Put differently harvested crop determination module is configured to determine when the header 325 is no longer loaded with harvested crop and/or is no longer taking in or harvesting more crop.

In another example, the heading determination module 220 determines the heading of the harvesting machine 130 and/or the header 325. The heading determination module 220 determines a first vector (not shown) between the center point of the harvesting machine 130 and an intersection point representing the heading of the harvesting machine 130 and the first location sensor 315 and determines a second vector (not shown) between the second location sensor and the intersection point representing the heading of the header 325. In some examples, the heading of the harvesting machine 130 and/or header 325 are determined using the intersection point whenever the first location sensor 315 and the second location sensor receives new location data (e.g., set of coordinates). In some examples, the heading of the harvesting machine 130 and/or header 325 are determined using both methods and the results of the two methods are compared. If the results are different by more than a threshold amount, the harvest management system 140 may generate and send a notification to the client device 110 associated with the harvesting machine 130 indicating that the harvesting machine 130 requires examination. For example, the camera 335, the first location sensor 315 or the second location sensor may not be functioning properly, the camera 335 may require recalibration, or the dimensions of the harvesting machine 130 and/or header 325 may need to be remeasured.

The operation module 225 generates instructions for operating the harvesting machine 130 based on the heading determination module and the harvested crop determination module. In one example, the heading determination module provides location and heading of the harvesting machine 130 and/or header 325. In another, and as previously described, the harvested crop determination modules provide one or more of the positions (or operational state) of the header 325 (raised or lowered), activation or deactivation of one or more components of the header 325 and the amount of harvested crop remaining on the header 325. Operation module 225 generates the instructions to cause the harvesting machine 130 to perform an action. In some examples, the harvesting machine 130 may be semi-autonomous or autonomous. The operation module 225 may determine a path for the harvesting machine 130 to take based on the headings of the harvesting machine 130 and cause the harvesting machine 130 to move along the path. In other examples, the harvesting machine 130 may be remotely controlled based on input from a human operator (e.g., farmer) via the client device 110. The harvest management system 140 may generate and present a user interface that includes a map of a field including a graphical element representing the farming machine 130 to the human operator. The graphical element may be positioned according to the heading of the harvesting machine 130 such that the human operator may operate the harvesting machine 130 accurately and safely.

In some examples, the operation module 225 generates instructions to cause the harvesting machine 130 to change operational states (e.g., raise or lower) of the header 325 and/or activate or deactivate one or more components (e.g., draper belt, gathering chain) of the header 325. The operation module 225 may determine durations that it takes change an operational state of the header 325 and activate or deactivate one or more components of the header 325. While the harvesting machine 130 is operating on the field 630, it may be desirable for the header 325 to be in the lowered position. However, while the harvesting machine 130 is located in the headland where the harvesting machine 130 turns around, it may be desirable for the header 325 to be in the raised position and with one or more components deactivated. As the harvesting machine 130 enters the headland, the operation module 225 may instruct the harvesting machine 130 to raise the header 325. The operation module 225 may, using the determination from the harvested crop determination module that the header 325 is sufficiently empty of harvested crop, instruct the header 325 to deactivate one or more components of the header 325. In this example, the deactivated components of the header 325 may include those enabling certain header 325 functionality such as draper belts, a reel, and a cutter bar, thus conserving power and since no crop will be harvested by the header 325. In another example, the deactivated components of the header 325 may include a gathering chain and central auger of a corn header 325, thus conserving power and since no crop will be harvested by the header 325. As the harvesting machine 130 leaves the headlands—or areas with terraces, waterways or other obstructions—the operation module 225 may instruct the harvesting machine 130 to activate the one or more components of the header 325 and begin lowering the header 325 based on, for example, one or more activation durations such that all desired components of the header 325 are in the desired operating state (i.e., certain previously deactivated components are reactivated) prior to encountering unharvested crop.

The harvesting machine 130 performs harvest tasks in a field. The field may include waterways, terraces, headlands, and/or interior portions (with respect to the headlands) with crops to be harvested. The harvesting machine 130 receives instructions for performing the harvest tasks from the harvest management system 140 and generates control instructions for controlling components (e.g., header 325) of the harvest machine 130 to perform the harvest tasks. An example harvesting machine 130 is described herein with respect to FIG. 3. The example harvesting machine 130 of FIG. 3 includes a header 325 that is removably or statically coupled to a front of the harvesting machine 130 and in a lowered position (i.e., proximate the ground for harvesting). The harvesting machine 130 may be manually controlled, remotely controlled, semi-autonomous, or autonomous and include a driving mechanism (e.g., a motor and drivetrain coupled to wheels) for traversing through the field. In other examples, the header 325 is coupled to the rear of the harvesting machine 130. In alternative examples, a different type of header 325 may be coupled to the side of the harvesting machine 130.

Generally, the header 325 is pivotally coupled to the harvesting machine 130 at one position (e.g., in front of the harvesting machine 130) such that the header 325 may be in a lowered harvest position proximate the ground or in a raised transport position at some suitable distance from the ground. Further, the heading of the harvesting machine 130 and the heading of the header 325 are aligned. However, some header 325 are configured to pivot side-to-side about a hitch, such that the heading of the harvesting machine 130 and the header 325 are different. The term “heading” is used to refer to the orientation of the harvesting machine 130 or the header 325 indicative of the future direction of motion. As generally understood and provided in U.S Patent Publication No. 20230240170, which is incorporated in its entirety by reference, the heading of the harvesting machine 130 may be represented by a first vector (not shown) that passes through the center of the harvesting machine 130 (e.g., geometric center of the harvesting machine 130). The heading of header 325 is represented by a second vector (not shown) that passes through the center of the header 325 (e.g., geometric center of the header 325), and the second vector at an angle θ from the first vector.

The harvesting machine 130 includes a first location sensor 315 that continuously collects geolocation and time information corresponding to the motion of the harvesting machine 130 and the header 325, respectively. In some examples the header 325 may include its own header 325 position sensor (not shown), and the position of the header 325 may be determined using continuously collected geolocation and time information from header 325 position sensor. The first location sensor 315 may be integrated with inertial measurement units (IMU) that detect acceleration and rotational rate along pitch, roll, and yaw axes. The first location sensor 315 provides the collected information to the harvest management system 140. The distances and offset of the first location sensor 315 (and, if any, the header 325 positions sensor) are fixed and may be measured by personnel associated with the harvest management system 140 before the harvesting machine 130 is deployed (e.g., manufacturer of the harvesting machine 130, test operator of harvest management system 140) or may be measured by a user of the harvesting machine 130 (e.g., farmer) and input to the harvest management system 140 after being deployed.

The harvesting machine 130 includes a camera 335 mounted to the front of harvesting machine 130 and directed to capture forward looking images of the header 325 and harvested material as the harvesting machine 130 travels through the field. In some examples, the camera 335 is installed to be aligned with the center line of the harvesting machine 130. In other examples, the camera 335 is installed elsewhere on the harvesting machine 130. The camera 335 is calibrated to determine intrinsic parameters such as local length, skew, distortion, and image center and extrinsic parameters such as position and orientation of the camera 335 relative to the harvesting machine 130.

When guiding the harvesting machine 130 through a field, the harvest management system needs to determine the heading of the harvesting machine 130 (and attached header 325, if any) within the field to predict the motion of the harvesting machine 130. In some examples, a first location sensor (e.g., GPS receiver) 315 may accurately determine the heading. One method of determining the heading is to compare the information collected by location sensors at different points in time and use the change in the positions over time to calculate the heading. This method for determining the heading can be effective when the harvesting machine 130 is moving at a speed above a threshold speed. However, when the harvesting machine 130 is moving a speed below the threshold speed, the heading may be inaccurate due to limits in the accuracy of location sensors, and when the harvesting machine 130 is stationary, the method cannot be used since there is no change in positions.

To determine accurate headings for the harvesting machine 130, the harvest management system 140 receives location information from one or more location position sensors associated with the harvester and/or header 325. The harvest management system 140 may generate instructions for operating the harvesting machine 130. For example, the harvest management system 140 may generate and transmit paths for the harvesting machine 130 to take or instructions to adjust the headings of the harvesting machine 130. The harvest management system 140 may use the determined harvesting machine 130 and/or header 325 position to determine when to raise the header 325 when entering a headland adjacent to a field or an area containing a waterway or terrace or other obstruction, as well as when to lower the header 325 when leaving a headland adjacent to a field or an area containing a waterway or terrace or other obstruction. Details on the harvest management system 140 are further described below with respect to FIG. 2.

Alternatively, as shown in FIG. 3, the harvest management system may use a forward looking camera 335 mounted on the harvester and capable of viewing the header 325 and/or an area in front of the header 325 to raise the header 325 when entering a headland adjacent to a field or an area containing a waterway or terrace or other obstruction, as well as when to lower the header 325 when leaving a headland adjacent to a field or an area containing a waterway or terrace or other obstruction.

FIGS. 4A-C show various aspects of a harvesting machine 130 with a header 325 in a field 630 having an unharvested crop portion 630a and a harvested crop portion 630b. As can be seen in FIGS. 4A and 4B, a harvesting machine 130 has a header 325 in a lowered position for harvesting crop from unharvested crop portion 630a. In the lowered position, header 325 may have certain components 170 activated such that harvested crop fills the header 325, i.e., the crop that has been removed from the surface of the field and transported to an internal area (e.g., a feederhouse 160) of the harvesting machine 130 for processing. FIG. 4C depicts a harvesting machine 130 with a header 325 in a raised position within field 630. In the raised position, header 325 may have certain components 170 deactivated such that header 325 is partially or mostly empty of harvested crop.

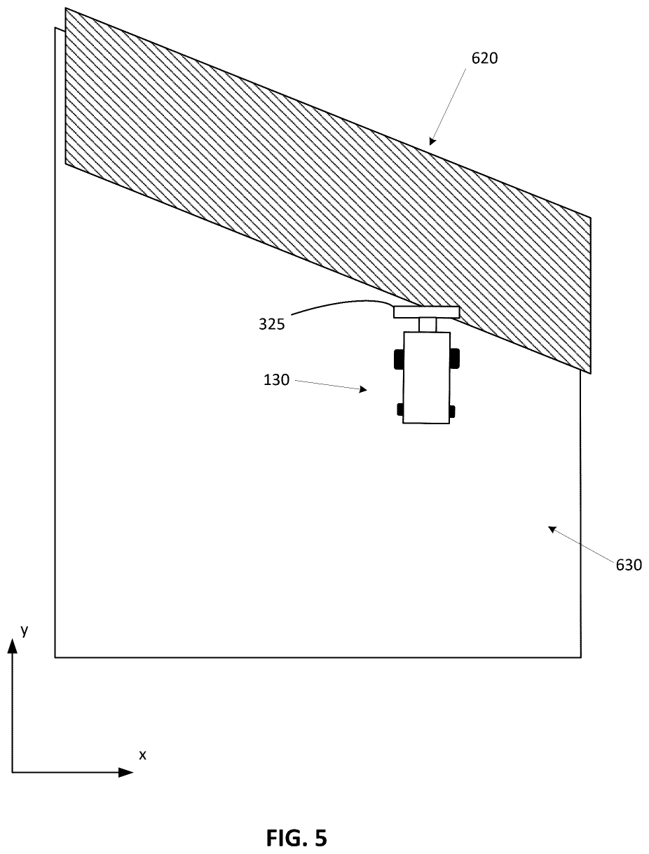

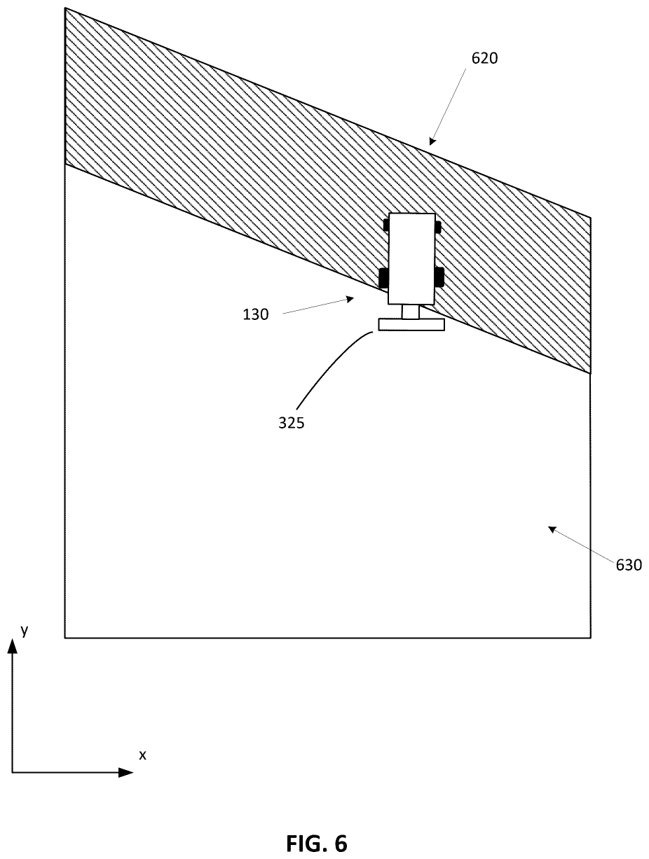

FIG. 5 illustrates a top view of a harvesting machine 130 and header 325 entering a headland 620, according to an example. The location of headland 620 may be determined in several ways. For example, the headland 620 may be determined by a coverage map that has been generated based on the harvesting machine 130 harvesting the headland 620 prior to harvesting the field 630. In some examples, the headland 620 may be determined based on an offset from the field boundary, and the harvesting machine 130 may harvest the headland 620 prior to harvesting the field 630. The harvesting machine 130 is traveling in the positive y-direction as shown. The harvesting machine 130 determines that the header 325 is within the headland 620 and is sufficiently unloaded of harvested crop (e.g., FIG. 4C) and, simultaneously or concurrently, the harvesting machine 130 may begin automatically raising the header 325 above the ground to a different operational state allowing for transport or movement within the field without damaging the header 325 and deactivating one or more components of the header 325. The harvesting machine 130 may then turn around in the headland and return into the field 630 to operate on the field 630 in the negative y-direction, as described with reference to FIG. 6.

FIG. 6 illustrates a top view of the harvesting machine 130 and header 325 exiting the headland 620, according to an example. The harvesting machine 130 may determine the amount of time it will take to lower the header 325 and/or activate one or more components of the header 325 to begin harvesting crop from the field 630 (see FIGS. 4A-4B). For example, based on a programmed route, a current position of the harvesting machine 130 and header 325, and a current speed of the harvesting machine 130, the harvesting machine 130 may calculate the amount of time until the header 325 will begin to enter the field 630. The harvesting machine 130 may begin to activate one or more components of the header 325 at a time such that the header 325 begins harvesting crop from the field 630 once a portion of the header 325 crosses the border between the headland 620 and the field 630. For example, the harvesting machine 130 may determine that it will take two seconds to activate the one or more components, and the harvesting machine 130 may begin two seconds prior to a predicted time that any portion of the harvesting machine 130 and/or header 325 enters the field 630.

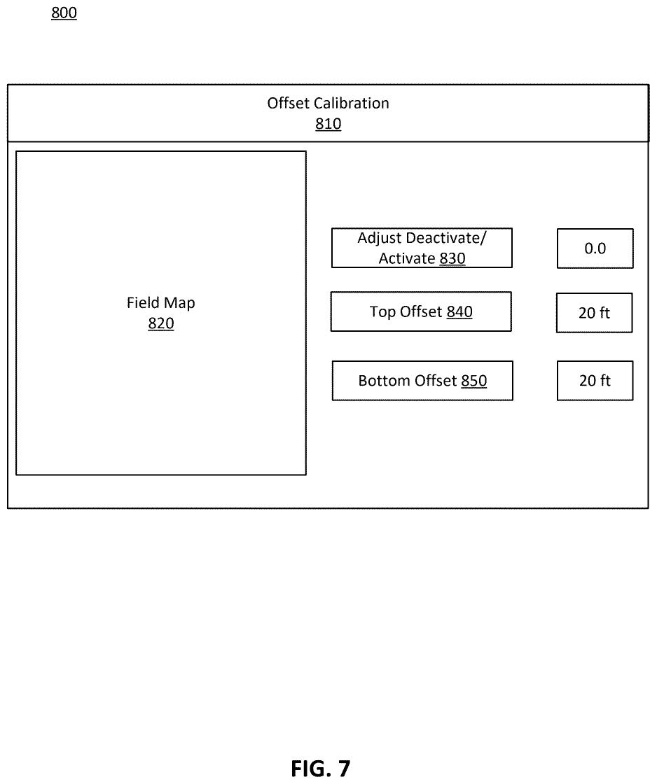

FIG. 7 illustrates a screenshot of a control interface 800 for offset calibration 810, according to an example. The control interface 800 may comprise a field map 820 that displays the field, the headland, and the position of the harvesting machine 130. The control interface 800 may permit a user to adjust 830 when the harvesting machine 130 begins to deactivate or activate one or more components of the header 325. For example, the harvesting machine 130 may be traversing the field in rows going from top to bottom across field map 820. The user may determine that the one or more components of the header 325 are being activated too slowly by approximately twenty feet when entering the field from the headland. The control interface 800 may comprise one or more offset field 840 where the user may input an offset from the border between the headland and the field such that the harvesting machine 130 activates or deactivates the one or more components of the header 325 in a more timely manner, e.g., faster, slower or delayed activation or deactivation.

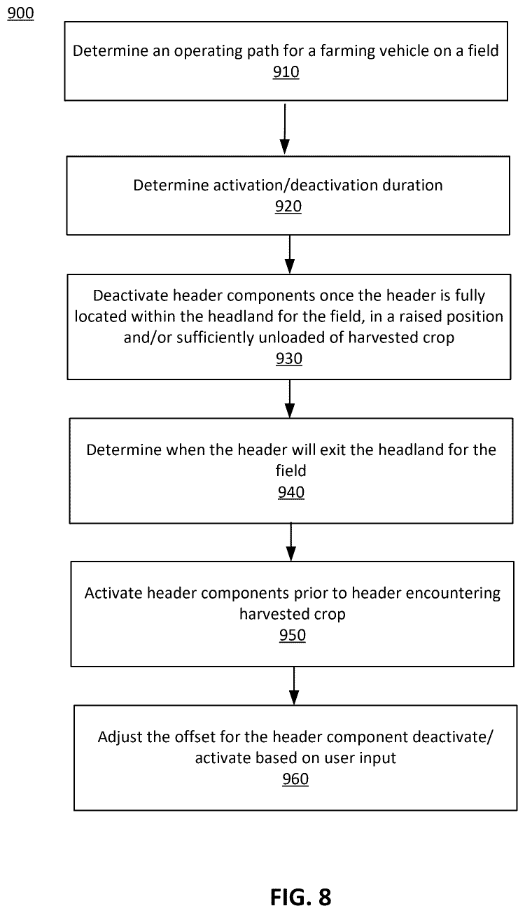

FIG. 8 illustrates a flowchart of a method 900 for automatically activating and deactivating one or more components of a header 325 for a harvesting machine 130, according to an example. A harvesting machine 130 may determine 910 an operating path for the harvesting machine 130 on a field. In some examples, the harvesting machine 130 may automatically determine the operating path based on known dimensions of the field. In one example, a user may input an operating path into a control interface for the harvesting machine 130. The operating path may cover all or a portion of the field. The operating path may additionally cover a portion of a headland where the harvesting machine 130 may turn around.

In another example, the method 900 for automatically deactivating one or more components of a header 325 for a harvesting machine 130 when at least one of the header is fully located within the headland of the field, in a raised position and utilizes a determination from the harvested crop determination module that the header 325 is sufficiently unloaded from harvested crop. In conjunction with this determination, the harvesting machine 130 may determine 920 one or more durations to deactivate one or more components of the header 325. The harvesting machine 130 may also activate one or more components, including certain components which were previously deactivated, of the header 325 prior to encountering crop. The harvesting machine 130 may measure the time it took to for the header 325 to become sufficiently unloaded from harvested crop and deactivate and/or activate the one or more components of the header 325.

In one example, the header 325 may comprise one or more sensors (e.g., cameras) that the header 325 has been sufficiently unloaded of harvested crop. In other examples, the harvesting machine 130 may monitor the duration of oil flowing through a selective control valve (SCV) that controls activation and/or deactivation of header 325 components. In some examples, a user may instruct the harvesting machine 130 to deactivate or activate header 325 components, and the harvesting machine 130 may measure the time between inputs. The harvesting machine 130 may instruct a user to activate and/or deactivate the header 325 components one or more times prior to beginning the operating path to time the duration of activating and/or deactivating header 325 components. In some examples, the harvesting machine 130 may time the duration to activate the header 325 components the first time as the harvesting machine 130 begins the operating path. The harvesting machine 130 may activate the header 325 components and proceed on the operating path.

The harvesting machine 130 may deactivate the header 325 components once the header 325 is fully located within the headland for the field and is determined sufficiently unloaded of harvested crop. The harvesting machine 130 may calculate or determine using cameras the position of the header 325 with respect to the border between the headland and the field. In some examples, the harvesting machine 130 and header 325 may cross the border at an angle non-perpendicular to the border. In such cases, different portions of the header 325 may enter the headland at different times and thus contain varying amounts of harvested crop. The harvesting machine 130 may determine using cameras that the entire header 325 has entered the headland and is sufficiently unloaded of harvested crop. Once the harvesting machine 130 determines that the header 325 is fully within the headland and is sufficiently unloaded of harvested crop, the harvesting machine 130 may automatically deactivate one or more header 325 components. The harvesting machine 130 may turn around in the headland and return into the field to continue on the operating path.

The harvesting machine 130 may calculate (or determine using cameras) 940 a time at which a portion of the header 325 will exit the headland and enter the field encountering standing and/or unharvested crop. For example, based on the operating path, a current position of the harvesting machine 130 and header 325, and a current speed of the harvesting machine 130, the harvesting machine 130 may calculate the amount of time until the header 325 begins to encounter standing crop. In one example, the harvesting machine 130 may determine, using a forward-looking camera 335, when the header 325 will begin to enter the field. The harvesting machine 130 may adjust the time in response to a change in any parameters. For example, in response to the user adjusting the speed of the harvesting machine 130 or the flow rate of oil through the SCV, the harvesting machine 130 may recalculate the time until the header 325 begins to enter the field. In some examples, if the harvesting machine 130 detects a change in speed of the harvesting machine 130, the process of activating one or more components may be adjusted to compensate for the difference in speed of the harvesting machine 130.

In some examples, the harvesting machine 130 may calculate the time at with the header 325 will enter the field based on a prescribed speed. For example, the harvesting machine 130 may traverse the field at a first speed, and the harvesting machine 130 may turn in the headland at a second speed which may be different than the first speed. The path and the speed of the harvesting machine 130 may be preplanned. The harvesting machine 130 may calculate the time at which the header 325 will enter the field based on the distance to be traveled in the headland and the prescribed second speed. In response to the operator varying the speed of the harvesting machine 130 from the prescribed speed, the harvesting machine 130 may recalculate the time to activate or deactivate the header 325 components based on the current speed. In examples where the operator is driving or turning manually, the harvesting machine 130 may calculate estimated times by assuming that the path across the field and through the turn may be adjacent to the previous path and turn conducted by the harvesting machine 130.

The harvesting machine 130 may activate 950 the header 325 components prior to entering the field. For example, based on the previously calculated activation duration, the harvesting machine 130 may determine that it will take two seconds to activate the header 325 components, and the harvesting machine 130 may begin activating the header 325 components two seconds prior to the predicted time that any portion of the header 325 enters the field. The harvesting machine 130 may activate or deactivate when the calculated time is equal to or within a threshold time of the determined activation or deactivation duration. For example, if the threshold time is 0.5 seconds and the lowering duration is two seconds, the harvesting machine 130 may begin lowering the header 325 2.5 seconds prior to time at which the header 325 is predicted to enter the field. The harvesting machine 130 may track the point at which the one or more header 325 components are activated to document areas of the field that have been operated on by the header 325. The harvesting machine 130 may proceed on the operating path.

The harvesting machine 130 may adjust 960 the offset for header 325 based on user input. Or the user may choose not to adjust the offset. In one example, the user may determine that the harvesting machine 130 is activating or deactivating the header 325 components too early or too late, or that the header 325 is sufficiently or insufficiently unloaded of harvested crop, and the user may adjust the offset such that the harvesting machine 130 activates or deactivates the header 325 components earlier or later based on the user's input. For example, the user may instruct the harvesting machine 130 to begin activating or deactivating the header 325 components twenty feet earlier than the harvesting machine 130 did on previous turns. In some examples, the harvesting machine 130 may adjust the offset, recalculate the activation duration, or adjust any other suitable parameter in response to a change in conditions, such as a change in operating condition of the harvesting machine 130 or a change in weather conditions which affects the timing or speed of the harvesting machine 130 in any relevant manner.

### Additional Configuration Considerations

In the description above, for purposes of explanation, numerous specific details are set forth in order to provide a thorough understanding of the illustrated system and its operations. It will be apparent, however, to one skilled in the art that the system can be operated without these specific details. In other instances, structures and devices are shown in block diagram form in order to avoid obscuring the system.

Reference in the specification to “one example” or “an example” means that a particular feature, structure, or characteristic described in connection with the example is included in at least one example of the system. The appearances of the phrase “in one example” in various places in the specification are not necessarily all referring to the same example.

Some portions of the detailed descriptions are presented in terms of algorithms or models and symbolic representations of operations on data bits within a computer memory. An algorithm is here, and generally, conceived to be steps leading to a desired result. The steps are those requiring physical transformations or manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some of the operations described herein are performed by a computer physically mounted within a machine. This computer may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of non-transitory computer readable storage medium suitable for storing electronic instructions.

The figures and the description above relate to numerous examples by way of illustration only. It should be noted that from the following discussion, alternative examples of the structures and methods disclosed herein will be readily recognized as viable alternatives that may be employed without departing from the principles of what is claimed.

One or more examples have been described above, examples of which are illustrated in the accompanying figures. It is noted that wherever practicable similar or like reference numbers may be used in the figures and may indicate similar or like functionality. The figures depict examples of the disclosed system (or method) for purposes of illustration only. One skilled in the art will readily recognize from the following description that alternative examples of the structures and methods illustrated herein may be employed without departing from the principles described herein.

Some examples may be described using the expressions “coupled” and “connected” along with their derivatives. It should be understood that these terms are not intended as synonyms for each other. For example, some examples may be described using the term “connected” to indicate that two or more elements are in direct physical or electrical contact with each other. In another example, some examples may be described using the term “coupled” to indicate that two or more elements are in direct physical or electrical contact. The term “coupled,” however, may also mean that two or more elements are not in direct physical or electrical contact with each other, but yet still co-operate or interact with each other. The examples are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, the use of “a” or “an” is employed to describe elements and components of the examples herein. This is done merely for convenience and to give a general sense of the system. This description should be read to include one or at least one and the singular also includes the plural unless it is obvious that it is meant otherwise.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Upon reading this disclosure, those of skill in the art will appreciate additional alternative structural and functional designs for a system and a process for automating the operational state of a header 325 for harvesting machine 130. Thus, while particular examples and applications have been illustrated and described, it is to be understood that the disclosed examples are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

What is claimed is:

1. A method comprising:
determining when a header of a harvesting machine has been raised;
selectively deactivating one or more header components while the header has raised;
determining when a header has lowered; and
activating one or more header components when the header has lowered.

2. The method of claim 1 further comprising using one or more sensors to determine when header has been lifted and lowered.

3. The method of claim 2 wherein the sensor is a forward-looking camera mounted to the harvesting machine.

4. The method of claim 3 wherein the camera and an associated controller detect the position of the header by measuring the height of one or more header components from the ground.

5. The method of claim 2 wherein the one or more sensor is a sensor on the feeder house, a sensor associated with a hydraulic solenoid and a switch.

6. The method of claim 1 further comprising the step of selectively deactivating one or more header components using a sensor configured to detect when the header is empty of harvested crop or no longer harvesting crop.

7. The method of claim 6 wherein the step of detecting when header is empty of harvested crop is performed by sensing property of a header component.

8. The method of claim 7, wherein the header component is a draper belt, and the property crop sensed is a measured weight of one or more draper belts.

9. The method of claim 1 further comprising raising a header when the harvesting machine is entering at least one of a headland, a previously harvested area, a terrace, or a waterway.

10. The method of claim 1, further comprising lowering a header when the harvesting machine is leaving at least one of a headland, a previously harvested area, a terrace, or a waterway.

11. The method of claim 1 further comprising deactivating header components of the harvesting machine using a coverage map to determine when the harvesting machine is in or approaching a region that has already been harvested.

12. The method of claim 1 further comprising activating header components of the harvesting machine using a coverage map to determine when the harvesting machine is in or approaching a region that has not been harvested.

13. The method of claim 1 wherein the header component is at least one of a draper belt, a reel and a cutter bar associated with the header.

14. The method of claim 1 wherein the header component is at least one of a gathering chain and a central auger associated with the header.

15. The method of claim 1 further comprising during the lowering of the header changing at least one of the time, rate, and speed at which the header components activate.

16. The method of claim 1 further comprising during the raising of the header changing at least one of the time, rate, and speed at which the header components deactivate.

17. The method of claim 1 wherein header is a draper head, corn head or windrower with a draper head.

18. A method comprising:
determining when a header of a harvesting machine has been raised;
determining when the header has been sufficiently unloaded of harvested crop; and
selectively deactivating one or more components of the header.

19. A system comprising:
a harvesting machine with a header for generating harvested crop;
a header sensor configured to determine when the operational state of the header has been changed;
a forward-looking sensor configured to determine when the header has been sufficiently unloaded of harvested crop; and
a controller configured to selectively deactivate or activate one or more components of the header when the operational state of the header is changed.

20. The system of claim 19 wherein header is a draper head, corn head or windrower with a draper head.
